(19) United States
(12) Patent Application Publication
(10) Pub. No.: US 2018/0335859 A1
(43) Pub. Date: Nov. 22, 2018

(54) MOUSE DEVICE

(71) Applicant: Primax Electronics Ltd., Taipei (TW)

(72) Inventors: Shao-Lun Hsiao, Taipei (TW); Yi-Guang Chen, Taipei (TW)

(21) Appl. No.: 15/790,894

(22) Filed: Oct. 23, 2017

(30) Foreign Application Priority Data
May 19, 2017 (TW) 106116694

(51) Int. Cl. G06F 3/0354; G01D 5/252

(52) U.S. Cl. CPC G06F 3/03543; G06F 3/038; G01D 5/252

(57) ABSTRACT

The present invention provides a mouse device, including a body, a circuit board, and a plurality of weight sensing units. The weight sensing units are configured to measure weights of counterweight blocks accommodated in the plurality of accommodating parts of the body. A processing unit of the circuit board is connected to the weight sensing units and is configured to generate and output a weight sensing signal according to the measurement result of the weight sensing units.

### FIELD OF THE INVENTION

The present invention relates to the field of input devices, and in particular, to a mouse device.

### BACKGROUND OF THE INVENTION

The development changed with each passing day to the science and technology, and the multimedia and computer era has arrived. Moreover, in a computer system, input devices that connect a computer host and a user play a significant role. The input devices include: a mouse device, a keyboard device, and a trackball, or the like. Since the mouse device may be held by a user with a palm to control movement of a cursor of the mouse and click selection of an image on a computer screen or function execution may be performed according to operations by fingers of the user, the mouse device has become the most common input device. For particular requirements, for example, for esport requirements in games, a mouse device capable of being counterweighed is now provided. A user may select to respectively dispose one or more counterweight blocks having a weight in one or more accommodating slots of the mouse device according to needs, so as to adjust the position of gravity center of the mouse device, and further improve the use stability of the mouse device.

However, the disadvantages of the conventional mouse device capable of being counterweighed lie in that: first, a user can place a counterweight block of a proper weight in each accommodating slot to enable the mouse device to have a proper position of gravity center only after repeatedly counterweighing the mouse device and operating the mouse after the counterweighing for multiple times; for example, when a user finds that the mouse device is easy to turn over when being operated, it indicates that the position of gravity center of the mouse device in this case is excessively high and the user needs to counterweigh the mouse device again; in view of the above, the user lacks proper assist in the process of counterweighing the mouse device, and can only continuously try and test; and second, a user who operates a mouse device that is not counterweighed by the user can obtain weight information of the mouse device only after disassembling a cover of the accommodating slot configured to accommodate the counterweight block in the mouse device.

According to the above description, the conventional mouse device has room to improve.

### SUMMARY OF THE INVENTION

The present invention is mainly directed to provide a mouse device, and in particular, relates to a mouse device capable of being counterweighed by a user and of which the body is provided with a weight sensing unit for measuring a weight of a counterweight block accommodated in each accommodating part.

In a preferable embodiment, the present invention provides a mouse device, including:

a body, including a plurality of accommodating parts, each of the accommodating parts being configured to accommodate a counterweight block;

a plurality of weight sensing units, respectively corresponding to the plurality of accommodating parts, and each sensing unit being configured to measure a weight of the counterweight block accommodated in the corresponding accommodating part; and

a circuit board, including a processing unit, the processing unit being electrically connected to the plurality of weight sensing units and generating and outputting at least one weight sensing signal according to the weight measured by each of the weight sensing units.

### BRIEF DESCRIPTION OF THE DRAWINGS

FIG. 1 is a schematic structural view of the appearance of a mouse device according to a preferable embodiment of the present invention;

FIG. 2 is a schematic concept diagram of a scenario in which the mouse device shown in FIG. 1 is connected to a computer system;

FIG. 3 is a schematic structural diagram of a part of the mouse device in FIG. 1;

FIG. 4 is a schematic structural diagram of a part of the mouse device in FIG. 1 after a bottom cover of the body of the mouse device is disassembled;

FIG. 5 is a schematic three-dimensional exploded view of accommodating parts, weight sensing units, a circuit board, first elastic members, and second elastic members of the mouse device in FIG. 1;

FIG. 6A is a schematic diagram of a sensing process of a weight sensing unit of the mouse device in FIG. 1 when a counterweight block having a first weight is disposed in an accommodating part; and

FIG. 6B is a schematic diagram of a sensing process of a weight sensing unit of the mouse device in FIG. 1 when a counterweight block having a second weight is disposed in an accommodating part.

### DETAILED DESCRIPTION OF THE PREFERRED EMBODIMENT

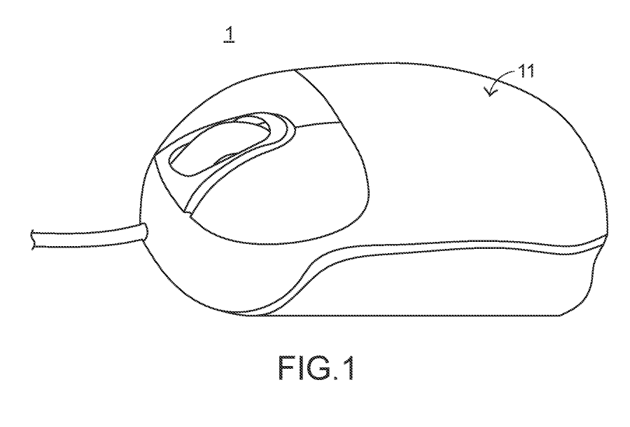

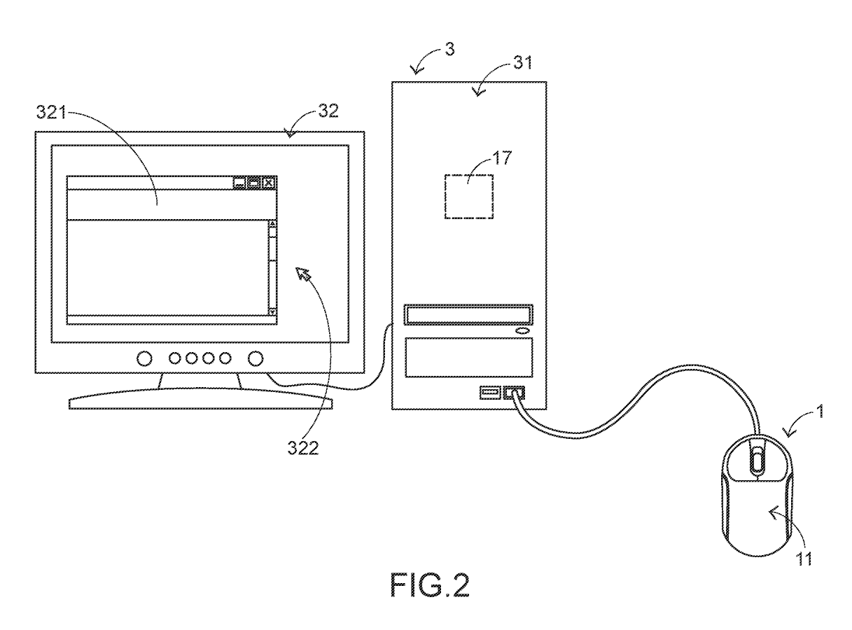

Referring to FIG. 1 and FIG. 2, FIG. 1 is a schematic structural view of the appearance of a mouse device according to a preferable embodiment of the present invention, and FIG. 2 is a schematic concept diagram of a scenario in which a mouse device shown in FIG. 1 is connected to a computer system. A computer system 3 includes a computer host 31 and a computer screen 32, the computer host 31 is separately connected to a mouse device 1 and a computer screen 32, and the computer screen 32 may display a cursor 322 and a window 321. The mouse device 1 is to be held by a user with a palm to move. The computer host 31 then moves the cursor 322 in the computer screen 32 according to a displacement of the mouse device 1. The specific embodiment and operating principles of the process in which a user controls the cursor 322 in the computer screen 32 to move by means of the mouse device 1 are well known by any person skilled in the art, and are not described in detail herein.

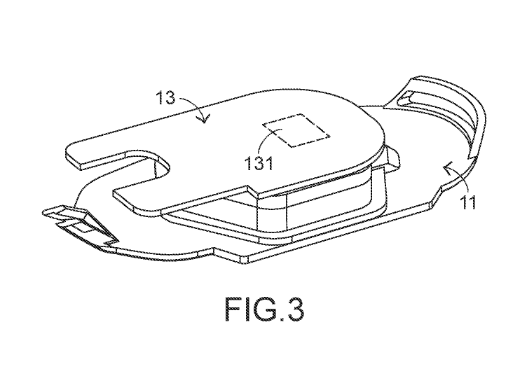

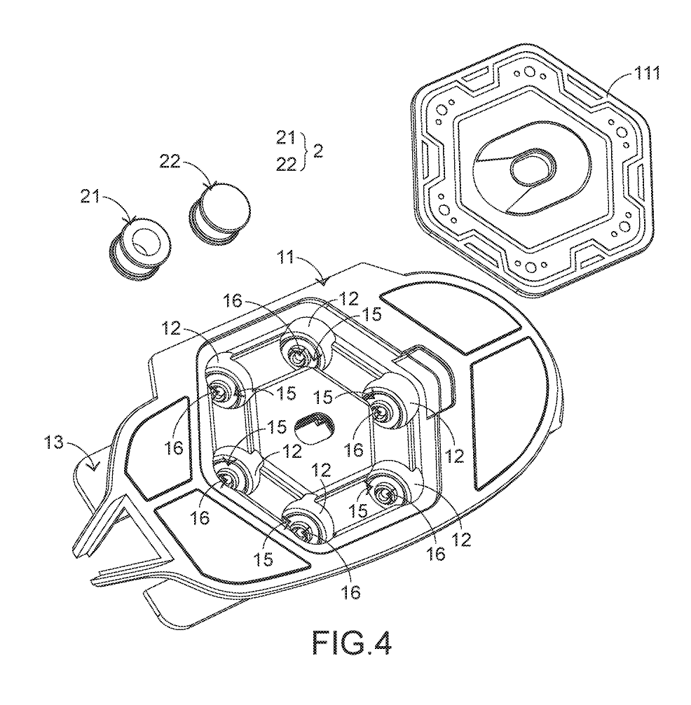

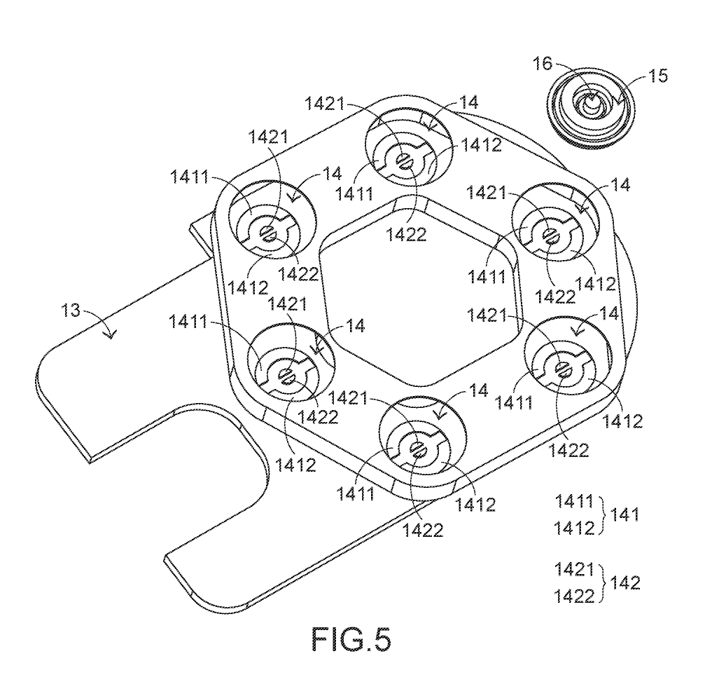

Referring to FIG. 1 and FIG. 3 to FIG. 5 synchronously, FIG. 3 is a schematic structural diagram of a part of the mouse device in FIG. 1, FIG. 4 is a schematic structural diagram of a part of the mouse device in FIG. 1 after a bottom cover of the body of the mouse device is disassembled, and FIG. 5 is a schematic three-dimensional exploded view of accommodating parts, weight sensing units, a circuit board, first elastic members, and second elastic members of the mouse device in FIG. 1. For clarity of illustration, only a part of the body of the mouse device is shown in FIG. 3 and FIG. 4, and FIG. 5 only shows one first elastic member 15 and one second elastic member 16. The mouse device 1 includes a body 11, weight sensing units 14, and a circuit board 13. The body 11 is to be held by a user with a palm to move, and a plurality of accommodating parts 12 and a lower cover 111 capable of being disassembled by a user are provided below the body 11. Each accommodating part 12 is configured to place a counterweight block 2 by a user. Moreover, the lower cover 111 covers the accommodating parts 12 to prevent the counterweight blocks 2 that are accommodated in the accommodating parts 12 from being dropping off from the body 11.

Second, each accommodating part 12 of the body 11 is not limited to accommodating a counterweight block 2, and the weights of any two counterweight blocks 2 that are accommodated in different accommodating parts 12 may be the same or different. A user may place a counterweight block 2 of a proper weight or may select not to place any counterweight block 2 in each accommodating part 12 according to actual application requirements, so as to obtain through adjustment a gravity center of the mouse device 1 that is suitable for the user, thereby further improving the smoothness and stability of the mouse device 1 in operation.

Further, the weight sensing units 14 are disposed in the body 11 and are respectively corresponding to the accommodating parts 12. The circuit board 13 includes a processing unit 131 connected to the plurality of weight sensing units 14. Each weight sensing unit 14 is configured to measure a weight of a counterweight block 2 accommodated in an accommodating part 12 corresponding to the weight sensing unit 14. The processing unit 131 is configured to generate and output a corresponding weight sensing signal according to the weight measured by each weight sensing unit 14.

Specifically, in this preferable embodiment, the counterweight blocks 2 configured to be placed in the accommodating parts 12 of the mouse device 1 are classified in a counterweight block 2 having a first weight and a counterweight block 2 having a second weight. Each weight sensing unit 14 includes a first sensing switch 141 and a second sensing switch 142. When a counterweight block 2 accommodated in an accommodating part 12 is the counterweight block 2 having a first weight, the first sensing switch 141 of the corresponding weight sensing unit 14 is on. When a counterweight block 2 accommodated in an accommodating part 12 is the counterweight block 2 having a second weight, both the first sensing switch 141 and the second sensing switch 142 of the corresponding weight sensing unit 14 are on. Therefore, the processing unit 131 may determine a weight of the counterweight block 2 accommodated in each accommodating part 12 according to whether the first sensing switch 141 and the second sensing switch 142 of each weight sensing unit 14 are on or off. Certainly, if there is a weight sensing unit 14 of which neither the first sensing switch 141 nor the second sensing switch 142 is on, the processing unit 131 determines that there is not a counterweight block 2 accommodated in the corresponding accommodating part 12. Finally, the processing unit 131 generates and outputs a corresponding weight sensing signal according to the measurement result of all the accommodating parts 12.

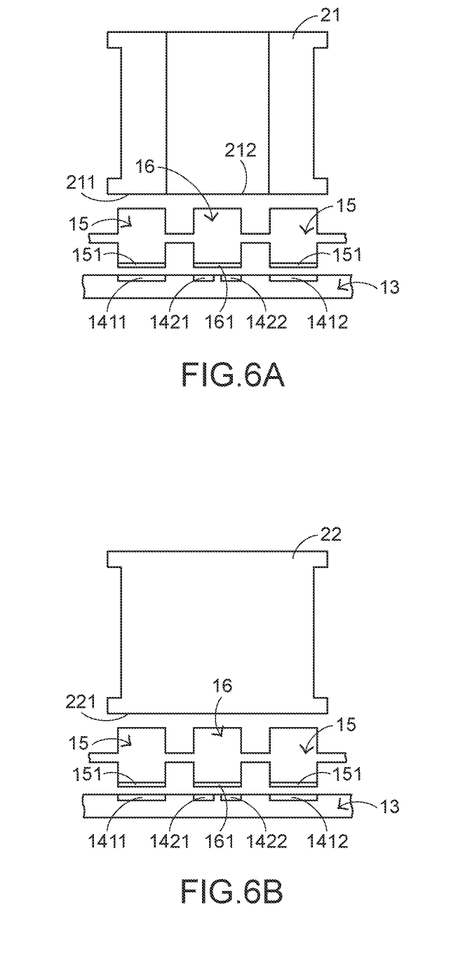

Further, in this preferable embodiment, the counterweight block 2 may be a hollow cylinder 21 having a first weight, or may also be a solid cylinder 22 having a second weight. The second weight is greater than the first weight, and the area of a top surface 211 (not shown in FIG. 1 to FIG. 5; referring to FIG. 6A) of the hollow cylinder 21 is equal to or approximately equal to that of a top surface 221 (not shown in FIG. 1 to FIG. 5; referring to FIG. 6B) of the solid cylinder 22. Further, each weight sensing unit 14 is disposed on the circuit board 13, the first sensing switch 141 includes a first electrode part 1411 and a second electrode part 1412 that are disposed at an interval, and the second sensing switch 142 includes a third electrode part 1421 and a fourth electrode part 1422 that are disposed at an interval. The area of a pattern formed by the first electrode part 1411 and the second electrode part 1412 is equal to or approximately equal to that of the top surface 211 of the hollow cylinder 21, and also is equal to or approximately equal to that of the top surface 221 of the solid cylinder 22. The area of a pattern formed by the third electrode part 1421 and the fourth electrode part 1422 is equal to or approximately equal to that of the area of a hollow part 212 (not shown in FIG. 1 to FIG. 5; referring to FIG. 6A) of the top surface 211 of the hollow cylinder 21.

Still, in this preferable embodiment, the mouse device 1 further includes a plurality of first elastic members 15 and a plurality of second elastic members 16 that are separately corresponding to the accommodating parts 12. A first elastic member 15 is disposed in the corresponding accommodating part 12, and is spaced apart for a distance from the corresponding first sensing switch 141. A second elastic member 16 is disposed in the corresponding accommodating part 12, and is spaced apart for a distance from the corresponding second sensing switch 142. A surface of each first elastic member 15 that contacts the corresponding first sensing switch 141 is provided with a first conductor 151 (referring to FIG. 6A and FIG. 6B). A surface of each second elastic member 16 that contacts the corresponding second sensing switch 142 is provided with a second conductor 161 (referring to FIG. 6A and FIG. 6B). Preferably, but not limited, the first elastic member 15 and the second elastic member 16 in the same accommodating part 12 are connected together.

Referring to FIG. 4, FIG. 5, and FIG. 6A simultaneously, FIG. 6A is a schematic diagram of a sensing process of a weight sensing unit of the mouse device in FIG. 1 when a counterweight block having a first weight is disposed in an accommodating part. As shown in FIG. 6A, when the counterweight block 2 (the hollow cylinder 21) having a first weight is placed in the accommodating part 12, the solid part of the top surface 211 of the counterweight block 2 presses against the first elastic member 15, such that the first conductor 151 of the first elastic member 15 contacts the first electrode part 1411 and the second electrode part 1412 of the first sensing switch 141 of the weight sensing unit 14 simultaneously. In this case, the first electrode part 1411 and the second electrode part 1412 are conducted, to further turn on the first sensing switch 141. The counterweight block 2 is the hollow cylinder 21, and therefore when the counterweight block 2 is placed in the accommodating part 12, the second elastic member 16 is not pressed by the counterweight block 2. Therefore, there is still a distance between the second elastic member 16 and the second elastic member 16 of the weight sensing unit 14, and the second sensing switch 142 is not triggered to be on.

Referring to FIG. 4, FIG. 5, and FIG. 6B simultaneously, FIG. 6B is a schematic diagram of a sensing process of a weight sensing unit of the mouse device in FIG. 1 when a counterweight block having a second weight is disposed in an accommodating part. As shown in FIG. 6B, when the counterweight block 2 (the solid cylinder 22) having a second weight is placed in the accommodating part 12, the top surface 221 of the counterweight block 2 presses against the first elastic member 15, such that the first conductor 151 of the first elastic member 15 contacts the first electrode part 1411 and the second electrode part 1412 of the first sensing switch 141 of the weight sensing unit 14 simultaneously. In this case, the first electrode part 1411 and the second electrode part 1412 are conducted, to further turn on the first sensing switch 141. Likewise, the counterweight block 2 is the solid cylinder 22, and therefore when the counterweight block 2 is placed in the accommodating part 12, the top surface 221 presses against the second elastic member 16, such that the second conductor 161 of the second elastic member 16 contacts the third electrode part 1421 and the fourth electrode part 1422 of the second sensing switch 142 of the weight sensing unit 14 simultaneously. In this case, the third electrode part 1421 and the fourth electrode part 1422 are conducted, to further turn on the second sensing switch 142.

Preferably, but not limited, the first conductor 151 of the first elastic member 15, the second conductor 161 of the second elastic member 16, the first electrode part 1411 and the second electrode part 1412 of the first sensing switch 141, and the third electrode part 1421 and the fourth electrode part 1422 of the second sensing switch 142 respectively contain the carbon material, or the first conductor 151 of the first elastic member 15, the second conductor 161 of the second elastic member 16, the first electrode part 1411 and the second electrode part 1412 of the first sensing switch 141, and the third electrode part 1421 and the fourth electrode part 1422 of the second sensing switch 142 respectively use spring connectors.

Subsequently, referring to FIG. 2 again, in this preferable embodiment, the mouse device 1 further includes a supervisor program 17 installed in the computer host 31. The supervisor program 17 is used for receiving the weight sensing signal generated and output by the processing unit 131 of the circuit board 13 of the mouse device 1 and providing mouse information according to the weight sensing signal. The mouse information is presented in the window 321 of the computer screen 32 for reference by a user. For example, the mouse information may include mouse gravity center information, used for indicating the current position of gravity center of the mouse device 1. A user may obtain whether the weight of the counterweight block 2 configured for each accommodating part 12 is appropriate according to the mouse gravity center information provided by the supervisor program 17. Therefore, the user has a reliable assist in the process of counterweighing the mouse device 1.

Still for example, the mouse information may include mouse weight information, used for indicating whether there is a counterweight block 2 accommodated in each accommodating part 12 of the mouse device 1 and a weight of the counterweight block 2 accommodated in each accommodating part 12. Therefore, a user who operates the mouse device 1 that is not counterweighed by the user may accelerate adaptation to operating the mouse device 1 by using the mouse weight information provided by the supervisor program 17. However, the mouse gravity center information and the mouse weight information are only implementation states of the mouse information, and do not constitute a limitation to the present invention. Any person of ordinary skill in the art may make equivalent change and design according to actual application requirements.

The above are only the preferable embodiments of the present invention, and the present invention needs not be limited to the disclosed embodiments. Therefore, all equivalent changes or modifications included within the spirit and scope of the present invention fall within the scope of the claims of the present invention.

What is claimed is:

1. A mouse device, comprising:
a body, comprising a plurality of accommodating parts, each of the accommodating parts being configured to accommodate a counterweight block;
a plurality of weight sensing units, respectively corresponding to the plurality of accommodating parts, and each sensing unit being configured to measure a weight of the counterweight block accommodated in the corresponding accommodating part; and
a circuit board, comprising a processing unit, the processing unit being electrically connected to the plurality of weight sensing units and generating and outputting at least one weight sensing signal according to the weight measured by each of the weight sensing units.

2. The mouse device according to claim 1, wherein a weight sensing unit of the weight sensing units includes a first sensing switch and a second sensing switch, and when the counterweight block accommodated in the accommodating part has a first weight, the first sensing switch of the corresponding weight sensing unit is on.

3. The mouse device according to claim 2, wherein when the counterweight block accommodated in the accommodating part has a second weight, the first sensing switch and the second sensing switch of the corresponding weight sensing unit are on.

4. The mouse device according to claim 3, wherein the counterweight block is a hollow cylinder having the first weight, or the counterweight block is a solid cylinder having the second weight, the area of a top surface of the hollow cylinder is equal to or approximately equal to that of a top surface of the solid cylinder.

5. The mouse device according to claim 4, wherein the first sensing switch comprises a first electrode part and a second electrode part that are disposed at an interval, and the area of a pattern formed by the first electrode part and the second electrode part is equal to or approximately equal to that of the top surface of the hollow cylinder and that of the top surface of the solid cylinder.

6. The mouse device according to claim 5, further comprising a plurality of first elastic member, each of the first elastic members being disposed between the counterweight block and the corresponding first sensing switch, wherein each of the first elastic members is provided with a first conductor, and when the counterweight block is disposed in the accommodating part, the corresponding first conductor contacts the first electrode part and the second electrode part of the corresponding first sensing switch, to conduct the corresponding first sensing switch.

7. The mouse device according to claim 4, wherein the second sensing switch comprises a third electrode part and a fourth electrode part that are disposed at an interval, and the area of a pattern formed by the third electrode part and the fourth electrode part is equal to or approximately equal to that of a hollow part of the top surface of the hollow cylinder.

8. The mouse device according to claim 7, further comprising a plurality of second elastic member, each of the second elastic members being disposed between the counterweight block and the corresponding second sensing switch, wherein each of the second elastic members is provided with a second conductor, and when the counterweight block having the second weight is disposed in the accommodating part, the corresponding second conductor contacts the third electrode part and the fourth electrode part of the corresponding second sensing switch, to conduct the corresponding second sensing switch.

9. The mouse device according to claim 1, further comprising a supervisor program, wherein the supervisor program is installed in a computer host, and is configured to receive the at least one weight sensing signal generated and output by the processing unit and provide a piece of mouse information according to the at least one weight sensing signal.

10. The mouse device according to claim 1, wherein the mouse information comprises a piece of weight information or a piece of mouse gravity center information.
